(19) United States
(12) Patent Application Publication
(10) Pub. No.: US 2026/0131696 A1
(43) Pub. Date: May 14, 2026

(54) ELECTRIFIED VEHICLE

(71) Applicant: TOYOTA JIDOSHA KABUSHIKI KAISHA, Toyota-shi (JP)

(72) Inventors: Kenta HIROOKA, Toyota-shi (JP); Yuki HAYAKAWA, Okazaki-shi (JP)

(73) Assignee: TOYOTA JIDOSHA KABUSHIKI KAISHA, Toyota-shi (JP)

(21) Appl. No.: 19/293,893

(22) Filed: Aug. 7, 2025

(30) Foreign Application Priority Data
Nov. 12, 2024 (JP) 2024-197758

(51) Int. Cl. B60L 58/13; B60L 50/60; B60L 58/19; H02M 7/5387

(52) U.S. Cl. CPC B60L 58/13; B60L 50/60; B60L 58/19; H02M 7/53871; B60L 2210/42; B60L 2260/26

(57) ABSTRACT

An electrified vehicle executes, in a case where an opening abnormality occurs in a series relay during execution of normal traveling control for turning on the series relay and controlling first and second inverters such that the electrified vehicle travels using electric power from first and second batteries, limp home control for turning on one of first and second parallel relays and controlling the first and second inverters such that the electrified vehicle travels using the electric power from one of the first and second batteries and a state of charge of the battery being equal to or greater than a threshold value.

### CROSS-REFERENCE TO RELATED APPLICATION

This application claims priority to Japanese Patent Application No. 2024-197758 filed on November 12, 2024. The disclosure of the above-identified application, including the specification, drawings, and claims, is incorporated by reference herein in its entirety.

### BACKGROUND

### 1. Technical Field

The present disclosure relates to an electrified vehicle.

### 2. Description of Related Art

In the related art, an electrified vehicle that can be charged from an external charger of a power supply facility to first and second power storage modules via a power supply cable connected to a charging port has been proposed (for example, see Japanese Unexamined Patent Application Publication No. 2020-150618 (JP 2020-150618 A)). The electrified vehicle includes a direct-parallel switching relay that is capable of switching a connection state of the first and second power storage modules to a series state and a parallel state in addition to the first and second power storage modules. The electrified vehicle further includes a power converter that transmits and receives power between the first and second power storage modules. The electrified vehicle further includes an in-vehicle controller that executes a voltage equalization process of controlling the power converter such that a voltage difference between the first and second power storage modules is equal to or less than a threshold value before parallel switching of the first and second power storage modules. The in-vehicle controller sets an opening and closing state of the direct-parallel switching relay to a predetermined diagnosis mode, and diagnoses an abnormality of the direct-parallel switching relay based on a detection value of a voltage detector that detects a voltage of the charging port.

### SUMMARY

In addition to the electrified vehicle having the hardware configuration, an electrified vehicle including a battery system and a traveling motor including a three-phase open winding has also been devised. The electrified vehicle further includes a first inverter connected to a positive electrode side line and a negative electrode side line to which the battery system is connected and connected to a first end side of the three-phase open winding. The electrified vehicle further includes a second inverter connected to the positive electrode side line and the negative electrode side line and connected to a second end side of the three-phase open winding. In the electrified vehicle, the battery system may include a first battery including a first positive electrode side terminal connected to the positive electrode side line and a first negative electrode side terminal. The battery system may further include a second battery including a second positive electrode side terminal and a second negative electrode side terminal connected to the negative electrode side line. The battery system may further include a series line connected to the first negative electrode side terminal and the second positive electrode side terminal. The battery system may further include a first parallel line connected to the first negative electrode side terminal and the negative electrode side line, and a second parallel line connected to the second positive electrode side terminal and the positive electrode side line. The battery system may further include a series relay provided in the series line, a first parallel relay provided in the first parallel line, and a second parallel relay provided in the second parallel line. In the electrified vehicle in the case, an issue is how the electrified vehicle travels in a limp home mode in a case where an opening abnormality occurs in the series relay when the electrified vehicle travels using electric power from the first and second batteries while the series relay is turned on.

A main object of an electrified vehicle of the present disclosure is that the electrified vehicle is able to travel in the limp home mode when the opening abnormality occurs in the series relay.

The electrified vehicle of the present disclosure adopts the following measures to achieve the main object.

An electrified vehicle of the present disclosure includes a battery system including a first battery including a first positive electrode side terminal connected to a positive electrode side line and a first negative electrode side terminal, a second battery including a second positive electrode side terminal and a second negative electrode side terminal connected to a negative electrode side line, a series line connected to the first negative electrode side terminal and the second positive electrode side terminal, a first parallel line connected to the first negative electrode side terminal and the negative electrode side line, a second parallel line connected to the second positive electrode side terminal and the positive electrode side line, a series relay provided in the series line, a first parallel relay provided in the first parallel line, and a second parallel relay provided in the second parallel line, a traveling motor including a three-phase open winding, a first inverter connected to the positive electrode side line and the negative electrode side line and connected to a first end side of the three-phase open winding, a second inverter connected to the positive electrode side line and the negative electrode side line and connected to a second end side of the three-phase open winding, and a control device configured to control the series relay, the first and second parallel relays, and the first and second inverters, in which the control device is configured to execute, in a case where an opening abnormality occurs in the series relay during execution of normal traveling control for turning on the series relay and controlling the first and second inverters such that the electrified vehicle travels using electric power from the first and second batteries, limp home control for turning on one of the first and second parallel relays and controlling the first and second inverters such that the electrified vehicle travels using the electric power from one of the first and second batteries of which a state of charge is equal to or greater than a threshold value.

In the electrified vehicle of the present disclosure, the control device is configured to execute the limp home control in a case where the opening abnormality occurs in the series relay during the execution of the normal traveling control. In the normal traveling control, the series relay is turned on, and the first and second inverters are controlled such that the electrified vehicle travels using the electric power from the first and second batteries. In the limp home control, one of the first and second parallel relays is turned on, and the first and second inverters are controlled such that the electrified vehicle travels using the electric power from one of the first and second batteries of which a state of charge is equal to or greater than a threshold value. As a result, when the opening abnormality occurs in the series relay, the vehicle can travel in the limp home mode.

In the electrified vehicle of the present disclosure, the control device may be configured to, as the limp home control, execute, in a case where the state of charge of the first battery is equal to or greater than a first threshold value, first limp home control for turning on the first parallel relay and controlling the first and second inverters such that the electrified vehicle travels using the electric power from the first battery, and execute, in a case where the state of charge of the first battery is less than the first threshold value and the state of charge of the second battery is equal to or greater than a second threshold value, second limp home control for turning on the second parallel relay and controlling the first and second inverters such that the electrified vehicle travels using the electric power from the second battery.

In the case, the battery system may further include a positive electrode side relay provided between the first battery and the first and second inverters of the positive electrode side line. The control device may turn off the positive electrode side relay when executing the second limp home control.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram showing a schematic configuration of a battery electric vehicle of an embodiment of the present disclosure;

FIG. 2 is an explanatory diagram showing a state of voltage application to first and second inverters during normal traveling control;

FIG. 3 is a flowchart showing an example of a processing routine executed by an ECU;

FIG. 4 is an explanatory diagram showing a state of voltage application to the first and second inverters during first limp home control; and

FIG. 5 is an explanatory diagram showing a state of voltage application to the first and second inverters during second limp home control.

### DETAILED DESCRIPTION OF EMBODIMENTS

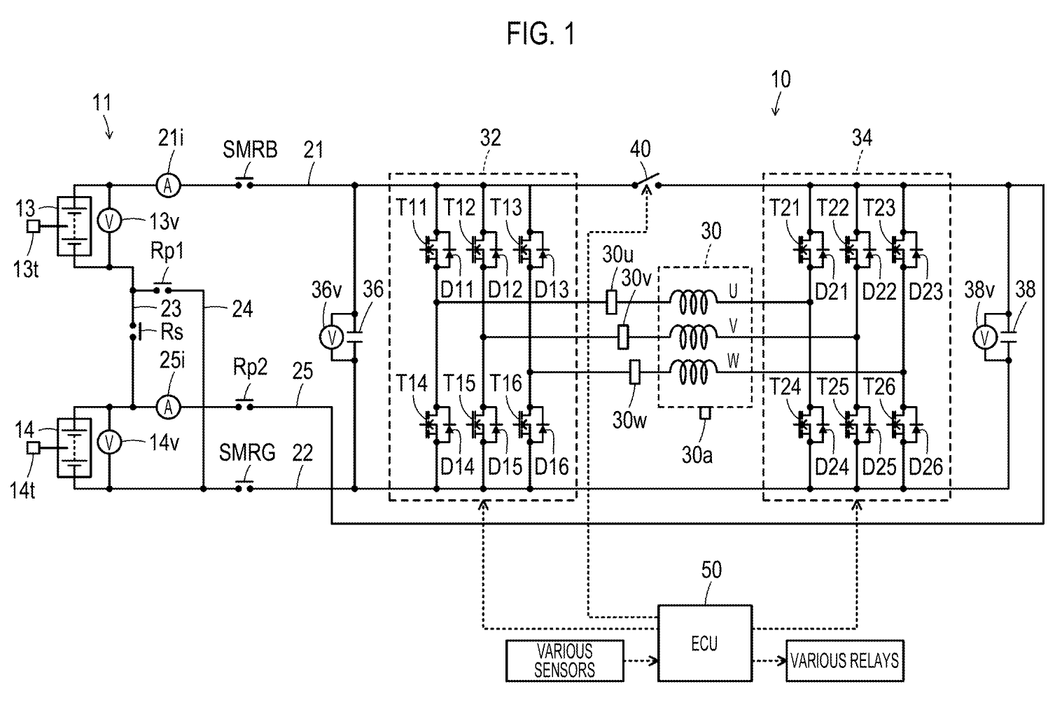

An embodiment for carrying out the present disclosure will be described with reference to the drawings. FIG. 1 is a schematic configuration diagram showing a schematic configuration of a battery electric vehicle 10 of an embodiment of the present disclosure. The battery electric vehicle 10 of the embodiment includes a battery system 11, a motor 30, first and second inverters 32, 34, and first and second capacitors 36, 38, as shown. The battery electric vehicle 10 further includes a switching switch 40, a system main relay SMR, and an electronic control unit (hereinafter, referred to as “ECU”) 50 (control device).

The battery system 11 includes first and second batteries 13, 14, a series line 23, first and second parallel lines 24, 25, a series relay Rs, and first and second parallel relays Rp1, Rp2. Each of the first and second batteries 13, 14 is configured as lithium ion secondary battery or nickel-hydrogen secondary battery. In the embodiment, the first and second batteries 13, 14 having the same specifications are used.

A first positive electrode side terminal of the first battery 13 is connected to a positive electrode side line 21. A second negative electrode side terminal of the second battery 14 is connected to a negative electrode side line 22. The series line 23 is connected to a first negative electrode side terminal of the first battery 13 and a second positive electrode side terminal of the second battery 14. A first parallel line 24 is connected to the first negative electrode side terminal of the first battery 13 and the negative electrode side line 22. A second parallel line 25 is connected to the second positive electrode side terminal of the second battery 14 and the second inverter 34 and the second capacitor 38 side that are on the positive electrode side line 21 with respect to the switching switch 40. The series relay Rs is provided in the series line 23. The first parallel relay Rp1 is provided in the first parallel line 24. The second parallel relay Rp2 is provided in the second parallel line 25.

The motor 30 is configured as a three-phase alternating current motor, and includes a rotor in which a permanent magnet is embedded in a rotor core and a stator in which three-phase (U-phase, V-phase, W-phase) coils (three-phase open winding) are wound around a stator core. The rotor is connected to a drive shaft connected to drive wheels via a differential gear.

The first inverter 32 is connected to the positive electrode side line 21 and the negative electrode side line 22, and is connected to a first end side of the three-phase coil of the motor 30. The second inverter 34 is connected to a side farther from the first and second batteries 13, 14 of the positive electrode side line 21 and the negative electrode side line 22 than the first inverter 32, and is connected to a second end side of the three-phase coil of the motor 30.

The first inverter 32 includes six transistors T11 to T16 as a plurality of switching elements, and six diodes D11 to D16 connected in parallel to the six transistors T11 to T16, respectively. The second inverter 34 includes six transistors T21 to T26 as switching elements, and six diodes D21 to D26 connected in parallel to the six transistors T21 to T26, respectively. As the transistors T11 to T16, T21 to T26, for example, a MOSFET or an IGBT is used. The transistors T11 to T16, T21 to T26 are disposed in pairs such that the transistors T11 to T16, T21 to T26 are source sides and sink sides with respect to the positive electrode side line 21 and the negative electrode side line 22. Each of connection points of two transistors corresponding to the transistors T11 to T16 is connected to each of the first end sides of the three-phase coils of the motor 30. Each of connection points of two transistors corresponding to the transistors T21 to T26 is connected to each of the second end sides of the three-phase coils of the motor 30.

The first capacitor 36 is connected to the vicinity of the first inverter 32 of the positive electrode side line 21 and the negative electrode side line 22. The second capacitor 38 is connected to the vicinity of the second inverter 34 of the positive electrode side line 21 and the negative electrode side line 22. In the embodiment, the battery system 11, the first capacitor 36, the first inverter 32, the second inverter 34, and the second capacitor 38 are connected to the positive electrode side line 21 and the negative electrode side line 22 in this order from the left side in FIG. 1. The switching switch 40 is provided between the first and second inverters 32, 34 of the positive electrode side line 21. As the switching switch 40, for example, a semiconductor switch or an insulation type switch is used.

The system main relay SMR includes a positive electrode side relay SMRB and a negative electrode side relay SMRG. The positive electrode side relay SMRB is provided between the connection point with the first positive electrode side terminal of the first battery 13 and the connection point with the first capacitor 36 in the positive electrode side line 21. The negative electrode side relay SMRG is provided between the connection point with the first parallel line 24 and the connection point with the first capacitor 36 in the negative electrode side line 22.

The ECU 50 includes a microcomputer having a CPU, a ROM, a RAM, a flash memory, an input/output port, and a communication port, or various drive circuits and various logic ICs. The ECU 50 receives signals from various sensors. For example, the ECU 50 receives a voltage Vb1 of the first battery 13 from a voltage sensor 13v and a temperature Tb1 of the first battery 13 from a temperature sensor 13t. For example, the ECU 50 receives a voltage Vb2 of the second battery 14 from a voltage sensor 14v and a temperature Tb2 of the second battery 14 from a temperature sensor 14t. The ECU 50 also receives a current IL1 of the positive electrode side line 21 from a current sensor 21i and a current IL2 of the second parallel line 25 from a current sensor 25i. The ECU 50 also receives a rotation position θm of the rotor of the motor 30 from a rotation position sensor 30a, and each of the phase currents Iu, Iv, Iw of the motor 30 from current sensors 30u, 30v, 30w. The ECU 50 also receives a voltage VH of the first capacitor 36 from a voltage sensor 36v and a voltage VL of the second capacitor 38 from a voltage sensor 38v. The ECU 50 also receives an on-off signal from a power switch and a shift position SP that is an operation position of a shift lever from a shift position sensor. The ECU 50 also receives an accelerator operation amount Acc that is an accelerator depression amount of the accelerator pedal from an accelerator pedal position sensor and a brake pedal position BP that is a depression amount of a brake pedal from a brake pedal position sensor. The ECU 50 also receives a vehicle speed V from a vehicle speed sensor.

The ECU 50 outputs various control signals. For example, the ECU 50 outputs the control signals to the transistors T11 to T16, T21 to T26 of the first and second inverters 32, 34. For example, the ECU 50 outputs the control signals to the series relay Rs, the first and second parallel relays Rp1, Rp2, the switching switch 40, the positive electrode side relay SMRB, and the negative electrode side relay SMRG.

The ECU 50 calculates states of charge SOC1, SOC2 based on the state of the series relay Rs, the first and second parallel relays Rp1, Rp2, the positive electrode side relay SMRB, and the negative electrode side relay SMRG, the current IL1, and the current IL2. The current IL1 is a current of the positive electrode side line 21. The current IL2 is a current of the second parallel line 25. The states of charge SOC1, SOC2 are the states of charge of the first and second batteries 13, 14. When the series relay Rs is turned on and the first and second parallel relays Rp1, Rp2 are turned off, the current IL1 of the positive electrode side line 21 is equal to the currents of the first and second batteries 13, 14. In addition, when the series relay Rs is turned off and the first parallel relay Rp1 is turned on, the current IL1 of the positive electrode side line 21 is equal to the current of the first battery 13. Further, when the series relay Rs is turned off and the second parallel relay Rp2 is turned on, the current IL2 of the second parallel line 25 is equal to the current of the second battery 14. The ECU 50 calculates an electrical angle θe or a rotation speed Nm of the motor 30 based on the rotation position θm of the rotor of the motor 30.

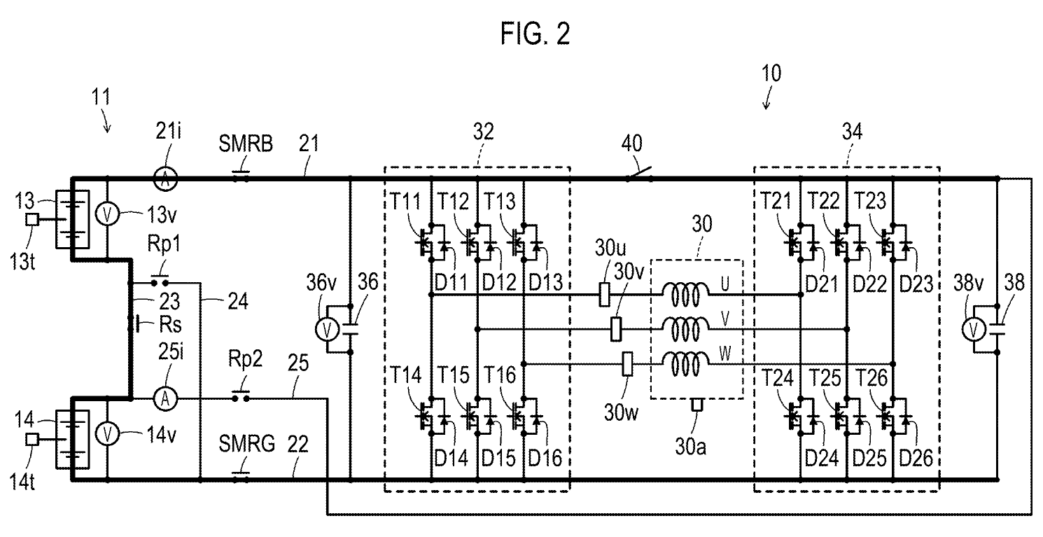

In the battery electric vehicle 10 of the embodiment, the ECU 50 basically turns on the series relay Rs and turns off the first and second parallel relays Rp1, Rp2. As a result, the ECU 50 connects the first and second batteries 13, 14 in series. In addition, the ECU 50 turns on the positive electrode side relay SMRB, the negative electrode side relay SMRG, and the switching switch 40. Then, the ECU 50 sets a request torque Td* requested for traveling based on the accelerator operation amount Acc and the vehicle speed V. The ECU 50 sets a torque command Tm* of the motor 30 such that the motor 30 travels by the set request torque Td*, and controls the first and second inverters 32, 34 based on the set torque command Tm*. In the control of the first and second inverters 32, 34, the first and second inverters 32, 34 are controlled by pulse width modulation control (PWM control) or rectangular wave control such that the motor 30 is driven based on the torque command Tm*. Such control is referred to as “normal traveling control”. FIG. 2 is an explanatory diagram showing a state of voltage application to the first and second inverters 32, 34 during the normal traveling control. During the normal traveling control, as shown by the bold solid line in FIG. 2, the voltage obtained by connecting the first and second batteries 13, 14 in series is applied to the first and second inverters 32, 34. In this way, the vehicle travels using the electric power from the first and second batteries 13, 14.

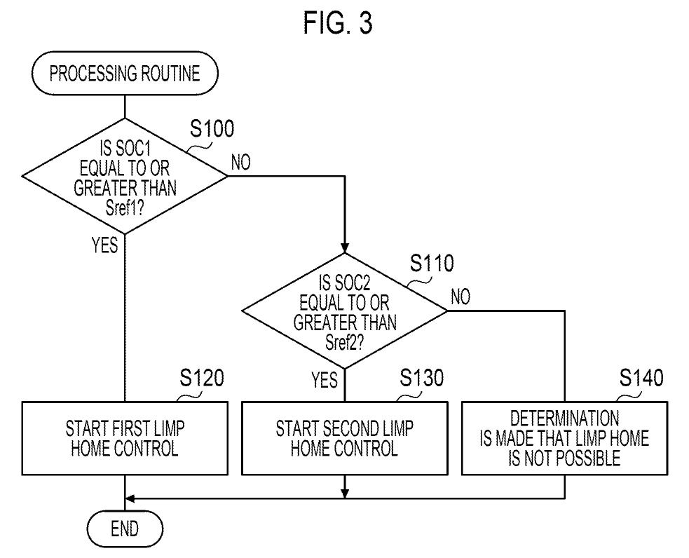

Next, the operation of the battery electric vehicle 10 of the embodiment, particularly, the operation when the opening abnormality occurs in the series relay Rs during the execution of the normal traveling control will be described. FIG. 3 is a flowchart showing an example of a processing routine executed by the ECU 50. The present routine is executed when the opening abnormality occurs in the series relay Rs during the execution of the normal traveling control.

When the present routine is executed, the ECU 50 first determines whether the state of charge SOC1 of the first battery 13 is equal to or greater than a threshold value Sref1 (S100). Here, the threshold value Sref1 is a threshold value used to determine whether first limp home control to be described later is executable.

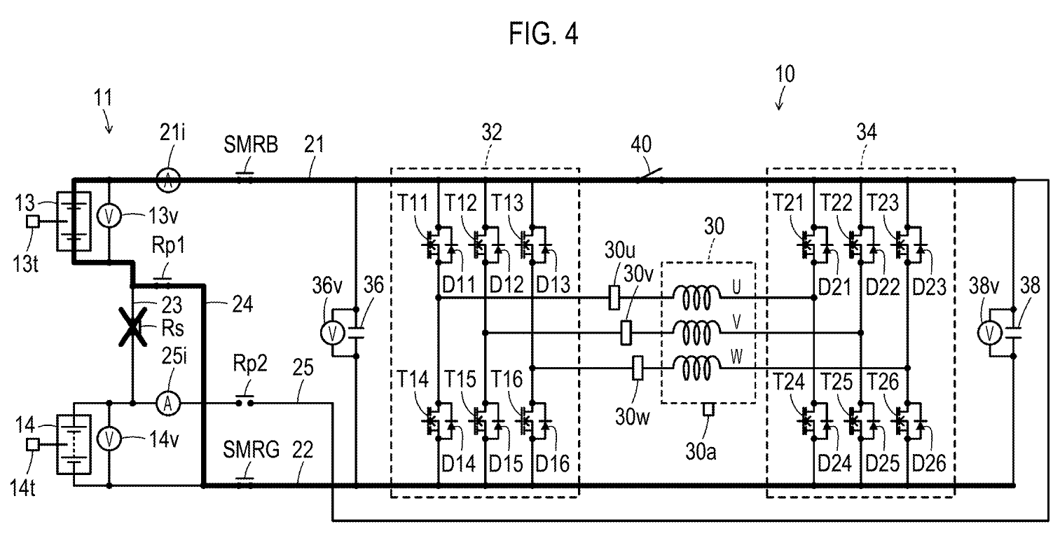

When determination is made in S100 that the state of charge SOC1 of the first battery 13 is equal to or greater than the threshold value Sref1, the first limp home control is determined to be executable, the first limp home control is started (S120), and the present routine is ended. In the first limp home control, the first parallel relay Rp1 is turned on, and the first and second inverters 32, 34 are controlled such that the vehicle travels (travels in a limp home mode) using only the electric power from the first battery 13 of the first and second batteries 13, 14. FIG. 4 is an explanatory diagram showing a state of voltage application to the first and second inverters 32, 34 during the first limp home control. During the first limp home control, as shown by the bold solid line in FIG. 4, the voltage of the first battery 13 is applied to the first and second inverters 32, 34. In this way, the vehicle can travel in the limp home mode using only the electric power from the first battery 13.

When determination is made in S100 that the state of charge SOC1 of the first battery 13 is less than the threshold value Sref1, determination is made that the first limp home control is not executable, and determination is made to whether the state of charge SOC2 of the second battery 14 is equal to or greater than a threshold value Sref2 (S110). Here, the threshold value Sref2 is a threshold value used to determine whether second limp home control described later is executable.

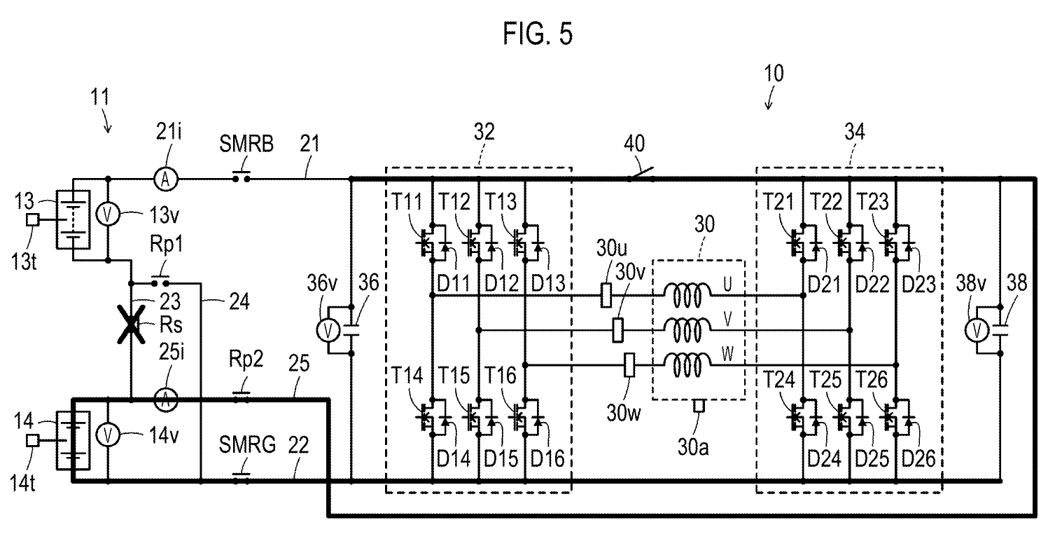

When determination is made in S110 that the state of charge SOC2 of the second battery 14 is equal to or greater than the threshold value Sref2, the second limp home control is determined to be executable, the second limp home control is started (S130), and the present routine is ended. In the second limp home control, the second parallel relay Rp2 is turned on, and the first and second inverters 32, 34 are controlled such that the vehicle travels (travels in a limp home mode) using only the electric power from the second battery 14 of the first and second batteries 13, 14. FIG. 5 is an explanatory diagram showing a state of voltage application to the first and second inverters 32, 34 during the second limp home control. During the second limp home control, as shown by the bold solid line in FIG. 5, the voltage of the second battery 14 is applied to the first and second inverters 32, 34. In this way, the vehicle can travel in the limp home mode using only the electric power from the second battery 14.

When determination is made in S110 that the state of charge SOC2 of the second battery 14 is less than the threshold value Sref2, determination is made that none of the first and second limp home controls is executable, and determination is made that limp home is not possible (S140), and the present routine is ended.

In the battery electric vehicle 10 of the embodiment described above, the ECU 50 performs the following process when the opening abnormality occurs in the series relay Rs and the state of charge SOC1 of the first battery 13 is equal to or greater than the threshold value Sref1. That is, the ECU 50 turns on the first parallel relay Rp1 and controls the first and second inverters 32, 34 such that the vehicle travels using the electric power from the first battery 13 as the first limp home control. In addition, when the opening abnormality occurs in the series relay Rs, the ECU 50 executes the following process when the state of charge SOC1 of the first battery 13 is less than the threshold value Sref1 and the state of charge SOC2 of the second battery 14 is equal to or greater than the threshold value Sref2. That is, the ECU 50 turns on the second parallel relay Rp2 and controls the first and second inverters 32, 34 such that the vehicle travels using the electric power from the second battery 14 as the second limp home control. With such control, when the opening abnormality occurs in the series relay Rs, the vehicle can travel in the limp home mode.

In the embodiment, when the opening abnormality occurs in the series relay Rs, the first limp home control is executed when the state of charge SOC1 of the first battery 13 is equal to or greater than the threshold value Sref1. The second limp home control is executed when the state of charge SOC1 of the first battery 13 is less than the threshold value Sref1 and the state of charge SOC2 of the second battery 14 is equal to or greater than the threshold value Sref2. However, the present disclosure is not limited to this. For example, when the opening abnormality occurs in the series relay Rs, the second limp home control may be executed when the state of charge SOC2 of the second battery 14 is equal to or greater than the threshold value Sref2 regardless of the state of charge SOC1 of the first battery 13. The first limp home control may be executed when the state of charge SOC2 of the second battery 14 is less than the threshold value Sref2 and the state of charge SOC1 of the first battery 13 is equal to or greater than the threshold value Sref1.

In the embodiment, the positive electrode side relay SMRB is held to be turned on when the second limp home control is executed, but the positive electrode side relay SMRB may be turned off.

The correspondence between the main elements of the embodiment and the main elements of the disclosure described in the column of the means for solving the problems will be described. In the embodiment, the first battery 13 is an example of a “first battery”, a second battery 14 is an example of the “second battery”, and the series line 23 is an example of a “series line”. The first parallel line 24 is an example of a “first parallel line”, the second parallel line 25 is an example of a “second parallel line”, and the battery system 11 is an example of a “battery system”. The motor 30 is an example of a “motor”, the first inverter 32 is an example of a “first inverter”, the second inverter 34 is an example of a “second inverter”, and the ECU 50 is an example of a “control device”.

The correspondence between the main elements of the embodiment and the main elements of the disclosure described in the column of means for solving the problem is an example for specifically describing the embodiment for implementing the disclosure described in the column of means for solving the problem. Therefore, the present disclosure is not intended to limit the elements of the disclosure described in the column of means for solving the problem. That is, the interpretation of the disclosure described in the column of the means for solving the problem should be made based on the description in the column, and the embodiment is merely a specific example of the disclosure described in the column of the means for solving the problem.

Although the embodiment for implementing the present disclosure has been described, the present disclosure is not limited to the embodiment, and can be implemented in various forms within the scope of the spirit of the present disclosure.

The present disclosure can be used in the manufacturing industry of the electrified vehicle.

What is claimed is:

1. An electrified vehicle comprising:
a battery system including a first battery including a first positive electrode side terminal connected to a positive electrode side line and a first negative electrode side terminal, a second battery including a second positive electrode side terminal and a second negative electrode side terminal connected to a negative electrode side line, a series line connected to the first negative electrode side terminal and the second positive electrode side terminal, a first parallel line connected to the first negative electrode side terminal and the negative electrode side line, a second parallel line connected to the second positive electrode side terminal and the positive electrode side line, a series relay provided in the series line, a first parallel relay provided in the first parallel line, and a second parallel relay provided in the second parallel line;
a traveling motor including a three-phase open winding;
a first inverter connected to the positive electrode side line and the negative electrode side line and connected to a first end side of the three-phase open winding;
a second inverter connected to the positive electrode side line and the negative electrode side line and connected to a second end side of the three-phase open winding; and
a control device configured to control the series relay, the first and second parallel relays, and the first and second inverters,
wherein the control device is configured to execute, in a case where an opening abnormality occurs in the series relay during execution of normal traveling control for turning on the series relay and controlling the first and second inverters such that the electrified vehicle travels using electric power from the first and second batteries, limp home control for turning on one of the first and second parallel relays and controlling the first and second inverters such that the electrified vehicle travels using the electric power from one of the first and second batteries of which a state of charge is equal to or greater than a threshold value.

2. The electrified vehicle according to claim 1, wherein:
the control device is configured to, as the limp home control,
execute, in a case where the state of charge of the first battery is equal to or greater than a first threshold value, first limp home control for turning on the first parallel relay and controlling the first and second inverters such that the electrified vehicle travels using the electric power from the first battery; and
execute, in a case where the state of charge of the first battery is less than the first threshold value and the state of charge of the second battery is equal to or greater than a second threshold value, second limp home control for turning on the second parallel relay and controlling the first and second inverters such that the electrified vehicle travels using the electric power from the second battery.

3. The electrified vehicle according to claim 2 wherein:
the battery system further includes a positive electrode side relay provided between the first battery and the first and second inverters of the positive electrode side line; and
the control device turns off the positive electrode side relay when executing the second limp home control.
